(19) United States
(12) Patent Application Publication
(10) Pub. No.: US 2018/0146716 A1
(43) Pub. Date: May 31, 2018

(54) ELECTRONIC CIGARETTE

(71) Applicant: SHENZHEN IVPS TECHNOLOGY CO., LTD., Shenzhen (CN)

(72) Inventor: Wen CHEN, Shenzhen (CN)

(73) Assignee: SHENZHEN IVPS TECHNOLOGY CO., LTD., Shenzhen (CN)

(21) Appl. No.: 15/881,649

(22) Filed: Jan. 26, 2018

(30) Foreign Application Priority Data
Nov. 29, 2016 (CN) 201621307722.2

(51) Int. Cl. A24F 47/00; H05B 3/44

(52) U.S. Cl. CPC A24F 47/008; H05B 3/44

(57) ABSTRACT

An electronic cigarette includes: a connecting holder, an atomizing cap, an atomizing holder and a heating wire; wherein the connecting holder is connected to one end of the atomizing cap, and the atomizing holder is inserted into the other end of the atomizing cap, the heating wire is arranged in the atomizing holder, the connecting holder includes an air inlet slot, a predetermined spacing is arranged between the atomizing holder and the atomizing cap, and side walls of the atomizing holder and the atomizing cap both have a through hole for tobacco oil to flow into and contact the heating wire.

### CROSS REFERENCE TO RELATED APPLICATIONS

The present application claims priority to Chinese Patent Application CN 201621307722.2 filed on Nov. 29, 2016.

### TECHNICAL FIELD

The present disclosure relates to the field of cigarette substitutes, and in particular, relates to an electronic cigarette.

### BACKGROUND

With the enhancement of awareness of health, more and more people have recognized the harm of smoking cigarettes. In recent years, some cigarette substitutes appear, for example, electronic cigarettes. A commonly used electronic cigarette is a low-voltage microelectronic atomizing device, which atomizes a solution having flavors of tobacco into smoke through a heating wire of an atomizer for smokers. As people are pursuing healthy life, the electronic cigarettes are being well populated. This new form of “smoking” has been more and more widely recognized and loved by smokers.

At present, in a conventional electronic cigarette, air intakes from the bottom, and an air flow passes through the bottom of the heating wire of the atomizer and carries away the smoke generated by combustion of the tobacco oil, and then enters the oral cavity of a user through a dropping nozzle. However, in this air intake manner, the smoke amount of the electronic cigarette is large, and in addition, the taste of the atomized tobacco oil is poor, thereby affecting user experience.

### SUMMARY

The present disclosure is intended to provide an electronic cigarette, such that an air flow enters the top of the electronic cigarette, and carries the atomized tobacco oil from the dropping nozzle to the oral cavity of a user. As such, a good taste is provided to the user, and user experience is enhanced.

An electronic cigarette includes: a connecting holder, an atomizing cap, an atomizing holder and a heating wire; wherein the connecting holder is connected to one end of the atomizing cap, and the atomizing holder is inserted into the other end of the atomizing cap, the heating wire is arranged in the atomizing holder, the connecting holder includes an air inlet slot, a predetermined spacing is arranged between the atomizing holder and the atomizing cap, and side walls of the atomizing holder and the atomizing cap both have a through hole for tobacco oil to flow into and contact the heating wire.

Optionally, the electronic cigarette further includes a spinning cap; wherein the spinning cap is connected to one end of the connecting holder that faces away from the atomizing cap, and the spinning cap has an inner diameter greater than an outer diameter of the connecting holder.

Optionally, a spring and a top bead are arranged on one end of a side wall of the connecting holder proximate to the spinning cap; wherein the spring is fixed to the connecting holder, the spring is connected to the top bead, and the top bead and the spinning cap are in contact to each other to fix the spinning cap.

Optionally, the atomizing cap and the connecting holder are connected via threads, the atomizing cap has external threads, and the connecting holder has internal threads.

Optionally, a sealing ring is arranged between the connecting holder and the atomizing cap.

Optionally, the electronic cigarette further includes a fixing cap; wherein the fixing cap is inserted into a side of the spinning cap that faces away from the connecting holder.

Optionally, the electronic cigarette further includes a dropping nozzle; wherein the dropping nozzle is inserted into a side of the fixing cap that faces away from the spinning cap.

Optionally, the electronic cigarette further includes an insulating ring; wherein the insulating ring is inserted into a side of the atomizing holder that faces away from the heating wire.

Optionally, the electronic cigarette further includes a contact electrode; wherein the contact electrode is inserted into a side of the insulating ring that faces away from the atomizing holder.

Optionally, the electronic cigarette further includes a power supply; wherein the power supply has a chamber for receiving an atomizer assembly, and the power supply is connected to the external threads of the connecting holder.

In the technical solution of the present disclosure, the electronic cigarette includes: a connecting holder, an atomizing cap, an atomizing holder and a heating wire; wherein the connecting holder is connected to one end of the atomizing cap, and the atomizing holder is plugged to the other end of the atomizing cap, the heating wire is arranged in the atomizing holder, the connecting holder includes an air inlet slot, a predetermined spacing is arranged between the atomizing holder and the atomizing cap, and side walls of the atomizing holder and the atomizing cap both have a through hole for tobacco oil to flow into and contact the heating wire. Air enters from the air inlet slot on the connecting holder at the upper part of the electronic cigarette, and an external air flow enters the atomizing holder via a gap between the atomizing cap and the atomizing holder, and flows through the top of the heating wire to carry the atomized tobacco oil from the dropping nozzle to the oral cavity of a user. As such, a good taste is provided to the user, and user experience is enhanced.

### BRIEF DESCRIPTION OF THE DRAWINGS

To describe the technical solution in embodiments of the present disclosure or in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is an exploded view of an electronic cigarette according to the present disclosure; and

FIG. 2 is a sectional view of some parts of the electronic cigarette according to the present disclosure.

Reference numerals and denotations thereof:

10—connecting holder

11—air inlet slot

12—spring

13—top bead

20—atomizing cap

21—sealing ring

30—atomizing holder

31—insulating ring

40—heating wire

50—spinning cap

60—fixing cap

61—dropping nozzle

70—contact electrode

80—power supply

The attainment of the objectives, functional features and advantages of the present disclosure are further described hereinafter with reference to the specific embodiments and the accompanying drawings.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present invention, but not all the embodiments of the present disclosure. Based on the embodiments of the present disclosure, all other embodiments derived by persons of ordinary skill in the art without any creative efforts shall fall within the protection scope of the present disclosure.

It should be noted that, all orientation-related indications (for example, upper, lower, left, right, front, rear, and the like) are only to interpret a relative position relationship between various parts in a specific posture and movements thereof (as shown in the drawings). If the specific posture is changed, the orientation-related indications shall corresponding vary.

In addition, terms of “first”, “second” in the present disclosure are only used for description, but shall not be understood as indication or implication of relative importance or implicit indication of the number of the specific technical features. Therefore, the features defined by the terms “first” and “second” may explicitly or implicitly include at least one of these features. In the description of the present disclosure, the term “more” or “a plurality of” signifies at least two, unless otherwise specified.

In the description of the present disclosure, it should be noted that unless otherwise specified and defined, the terms “mounted”, “coupled”, “connected” and “fixed” and derivative forms thereof shall be understood in a broad sense, which, for example, may be understood as fixed connection, detachable connection or integral connection; may be understood as mechanical connection or electrical connection, or understood as direct connection, indirect connection via an intermediate medium, or communication between the interiors of two elements or interactions between two elements, unless otherwise specified. Persons of ordinary skill in the art may understand the specific meanings of the above terms in the present disclosure according to the actual circumstances and contexts.

The technical solutions according to various embodiments of the present disclosure may be combined, as long as persons of ordinary skills in the art may practice the technical solution combinations. When combinations of the technical solutions are contradicted or fail to be implemented, it should be considered that the combinations are not existent, and are not within the protection scope of the present disclosure.

The present disclosure provides an electronic cigarette.

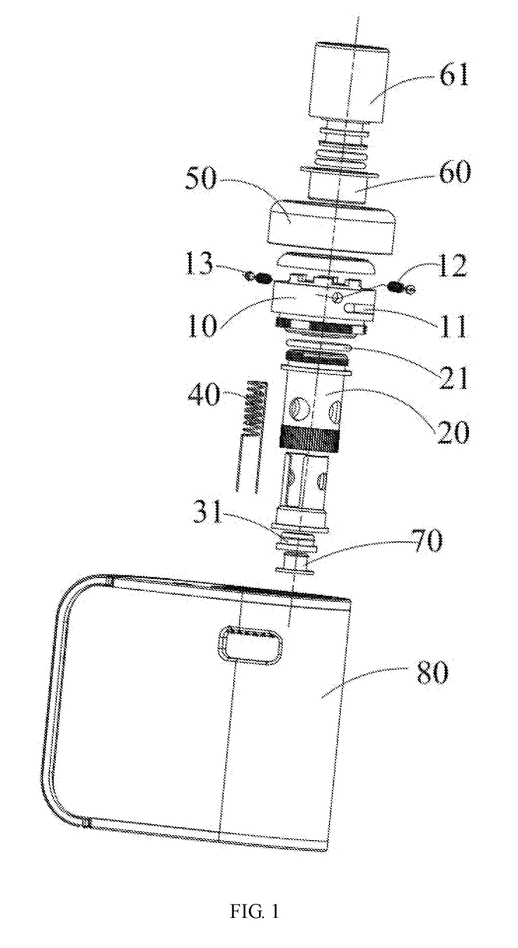

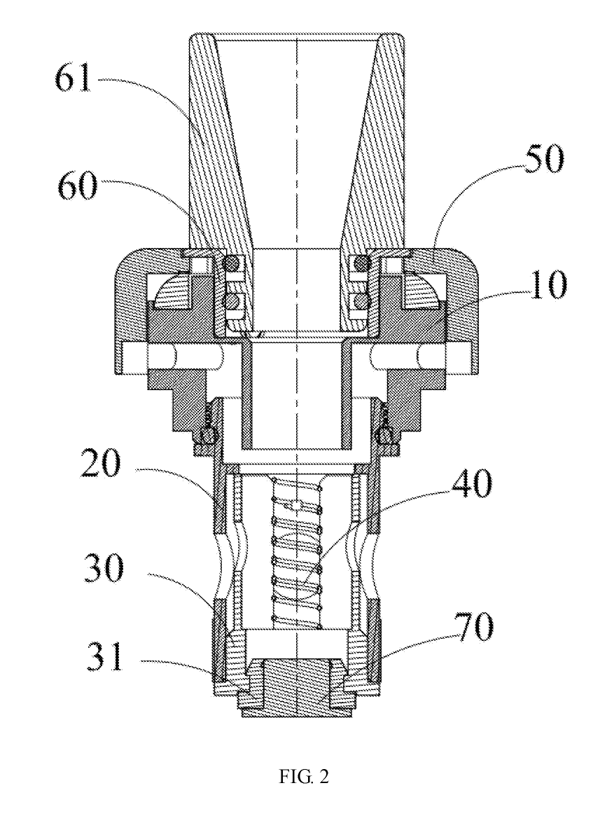

Referring to FIG. 1 to FIG. 2, in an embodiment of the present disclosure, the electronic cigarette includes: a connecting holder 10, an atomizing cap 20, an atomizing holder 30 and a heating wire 40; wherein the connecting holder 10 is connected to one end of the atomizing cap 20, and the atomizing holder 30 is inserted into the other end of the atomizing cap 30, the heating wire 40 is arranged in the atomizing holder 30, the connecting holder 10 includes an air inlet slot 11, a predetermined spacing is arranged between the atomizing holder 30 and the atomizing cap 20, and side walls of the atomizing holder 30 and the atomizing cap 20 both have a through hole (not shown in the drawings) for tobacco oil to flow into and contact the heating wire 40.

In this embodiment, air enters from the air inlet slot 11 on the connecting holder 10 at the upper part of the electronic cigarette, and an external air flow enters the atomizing holder 30 via a gap between the atomizing cap 20 and the atomizing holder 30, and flows through the top of the heating wire 40 to carry the atomized tobacco oil from the dropping nozzle to the oral cavity of a user. As such, a good taste is provided to the user, and user experience is enhanced.

Optionally, the electronic cigarette further includes a spinning cap 50; wherein the spinning cap 50 is connected to one end of the connecting holder 10 that faces away from the atomizing cap 20, and the spinning cap 50 has an inner diameter greater than an outer diameter of the connecting holder 10.

As an optional embodiment, by virtue of the spinning cap 50 whose inner diameter is greater than the outer diameter of the connecting holder 10, the spinning cap 50 is capable of blocking the air inlet slot 11 of the connecting holder 10, such that the external air flow first flows through an annular slot (not shown in the drawings) formed between the spinning cap 50 and the connecting holder 10, and afterwards enters the air inlet slot 11. In this way, the external foreign substances, for example, dust, flies and the like, are prevented from entering the interior of the electronic cigarette, and the operation reliability of the electronic cigarette is enhanced.

Specifically, a spring 12 and a top bead 13 are arranged on one end of a side wall of the connecting holder 10 proximate to the spinning cap 50; wherein the spring 12 is fixed to the connecting holder 10, the spring 12 is connected to the top bead 13, and the top bead 13 and the spinning cap 50 are in contact to each other to fix the spinning cap 50.

As an optional embodiment, it should be understood that a receiving slot (not shown in the drawings) may also be arranged at a corresponding position on the inner side wall of the spinning cap 50. The receiving slot may receive the spring 12 and the top bead 13 ejected by the spring 12, and be configured to fix the spinning cap 50.

Optionally, the atomizing cap 20 and the connecting holder 10 are connected via threads, the atomizing cap 20 has external threads, and the connecting holder 10 has internal threads.

As an optional embodiment, by virtue of the threads and the thread-connection, the disassembly of the parts of the electronic cigarette is improved, and convenience is brought to production and use thereof.

Optionally, a sealing ring 21 is arranged between the connecting holder 10 and the atomizing cap 20.

As an alternative embodiment, by virtue of the sealing ring 21, sealing performance of the electronic cigarette is improved, the atomized tobacco oil is prevented from leaking between the connection holder 10 and the atomizing cap 20, and operation reliability of the electronic cigarette is enhanced.

Optionally, the electronic cigarette further includes a fixing cap 60; wherein the fixing cap 60 is inserted into a side of the spinning cap 50 that faces away from the connecting holder 10.

As an optional embodiment, the fixing cap 60 is fixed via insertion, which improves disassembly of the structure of the electronic cigarette, and simplifies the structure.

Optionally, the electronic cigarette further includes a dropping nozzle 61; wherein the dropping nozzle 61 is inserted into a side of the fixing cap 60 that faces away from the spinning cap 50.

As an optional embodiment, the dropping nozzle is fixed to the main body of the electronic cigarette by virtue of being inserted into the fixing cap 60, which facilitates cigarette replacement for users, and improves use convenience.

Optionally, the electronic cigarette further includes an insulating ring 31; wherein the insulating ring 31 is inserted into a side of the atomizing holder 30 that faces away from the heating wire 40.

As an optional embodiment, the insulating ring 31 is inserted and fixed into the atomizing holder 30, which improves disassembly of the structure of the electronic cigarette, and simplifies the structure.

Preferably, the electronic cigarette further includes a contact electrode 70; wherein the contact electrode 70 is inserted into a side of the insulating ring 31 that faces away from the atomizing holder 30.

As an optional embodiment, the contact electrode 70 is connected to a positive electrode/negative electrode of the heating wire 40, and meanwhile the other end of the contact electrode 70 is connected to the power supply 80 of the electronic cigarette and configured to supply power to the heating wire.

Optionally, the electronic cigarette further includes a power supply 80; wherein the power supply 80 has a chamber (not shown in the drawings) for receiving an atomizer assembly, and the power supply 80 is connected to the external threads of the connecting holder 10.

As an optional embodiment, the power supply 80 is as illustrated in FIG. 1, and is a structure similar to a rectangular cuboid. The power supply 80 has a chamber for receiving atomizing parts, including: the atomizing cap 20, the atomizing holder 30, the heating wire 40, the insulating ring 31, the contact electrode 70 and the like. The power supply 80 is connected to the external threads of the connecting holder 10. These parts are concealed in a built-in chamber of the power supply 80, such that the appearance of the electronic cigarette is more compact and beautiful.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

What is claimed is:

1. An electronic cigarette, comprising: a connecting holder, an atomizing cap, an atomizing holder and a heating wire; wherein the connecting holder is connected to one end of the atomizing cap, and the atomizing holder is inserted into the other end of the atomizing cap, the heating wire is arranged in the atomizing holder, the connecting holder comprises an air inlet slot, a predetermined spacing is arranged between the atomizing holder and the atomizing cap, and side walls of the atomizing holder and the atomizing cap both have a through hole for tobacco oil to flow into and contact the heating wire.

2. The electronic cigarette according to claim 1, further comprising a spinning cap; wherein the spinning cap is connected to one end of the connecting holder that faces away from the atomizing cap, and the spinning cap has an inner diameter greater than an outer diameter of the connecting holder.

3. The electronic cigarette according to claim 2, wherein a spring and a top bead are arranged on one end of a side wall of the connecting holder proximate to the spinning cap; wherein the spring is fixed to the connecting holder, the spring is connected to the top bead, and the top bead and the spinning cap are in contact to each other to fix the spinning cap.

4. The electronic cigarette according to claim 1, wherein the atomizing cap and the connecting holder are connected via threads, the atomizing cap has external threads, and the connecting holder has internal threads.

5. The electronic cigarette according to claim 1, wherein a sealing ring is arranged between the connecting holder and the atomizing cap.

6. The electronic cigarette according to claim 2, further comprising a fixing cap; wherein the fixing cap is inserted into a side of the spinning cap that faces away from the connecting holder.

7. The electronic cigarette according to claim 6, further comprising a dropping nozzle; wherein the dropping nozzle is inserted into a side of the fixing cap that faces away from the spinning cap.

8. The electronic cigarette according to claim 1, further comprising an insulating ring; wherein the insulating ring is inserted into a side of the atomizing holder that faces away from the heating wire.

9. The electronic cigarette according to claim 8, further comprising a contact electrode; wherein the contact electrode is inserted into a side of the insulating ring that faces away from the atomizing holder.

10. The electronic cigarette according to claim 1, further comprising a power supply; wherein the power supply has a chamber for receiving an atomizer assembly, and the power supply is connected to the external threads of the connecting holder.
